(19) United States
(12) Patent Application Publication
(10) Pub. No.: US 2004/0095282 A1
(43) Pub. Date: May 20, 2004

(54) Antenna device

(76) Inventors: Susumu Fukushima, Osaka (JP); Yuji Osumi, Nara (JP)

Correspondence Address: WENDEROTH, LIND & PONACK, L.L.P., 2033 K STREET N. W., SUITE 800, WASHINGTON, DC, 20006-1021, US

(21) Appl. No.: 10/644,732

(22) Filed: Aug. 21, 2003

(30) Foreign Application Priority Data
Aug. 22, 2002 (JP) 2002-241424
Aug. 23, 2002 (JP) 2002-243068
Aug. 29, 2002 (JP) 2002-250899

(51) Int. Cl. H01Q 1/24

(52) U.S. Cl. 343/702; 343/846

(57) ABSTRACT

An antenna device of the invention has a configuration in which a first radiation plate and a second radiation plate of which diameter or one side is about ½ wavelength in electrical length are disposed on a ground plate at an arbitrary interval, a first power feed port and a second power feed port provided on the first radiation plate are disposed so that the straight lines linking each power feed port position and the middle point of the first radiation plate may be orthogonal to each other, a third power feed port and a fourth power feed port provided on the second radiation plate are disposed so that the straight lines linking each power feed port position and the middle point of the second radiation plate may be orthogonal to each other, and these straight lines are disposed to have an angle of 45 degrees to a straight line linking the first power feed port position and the middle point of the first radiation plate and to a straight line linking the second power feed port position and the middle point of the first radiation plate.

### FIELD OF THE INVENTION

The present invention relates to an antenna device such as diversity antenna used in mobile communications.

### BACKGROUND OF THE INVENTION

Hitherto, in long-distance wireless transmission route, for example, reception level fluctuates significantly depending on place, time and polarization, generally, due to occurrence of fading, and it has been attempted to prevent fluctuations of reception level by employing diversity technology. Conventional diversity antennas are shown in FIG. 30A and FIG. 30B.

FIG. 30A shows a space diversity antenna having four monopole antennas 101 disposed perpendicularly on a ground plate 100 at a specific interval. In each monopole antenna 101, received signal levels are compared, and the higher one is selected, and deep attenuation of reception signal caused depending on place of reception or the like can be lessened. To enhance the effect of space diversity, it is required to lower the correlation coefficient by extending the mutual distance of antennas.

FIG. 30B shows a directive diversity antenna having a first dipole antenna 102 and a second dipole antenna 103 disposed orthogonally so that the directivity of each antenna may cross orthogonally. Since fading occurs in every polarized wave, in one place, for example, vertical polarized wave is not received at all while horizontal polarized wave is received by a large reception power. In such a case, by using a directive diversity antenna, deep attenuation of reception power can be lessened.

However, when the space diversity antenna in FIG. 30A is applied in a mobile terminal, it is extremely difficult to keep a specific distance among antennas in the recent downsizing trend of mobile terminals. In a small portable terminal, if antennas are closely disposed to each other to realize a space diversity, since the directivity pattern on the horizontal plane of each monopole antenna 101 in FIG. 30A is nondirectional, arbitrary incoming waves are similarly received by the antennas and it is highly possible that the reception voltages of the antennas be identical, and the correlation coefficient of the monopole antennas may deteriorate significantly.

Or, when the directive diversity antennas in FIG. 30B are disposed parallel to each other on the ground, the bandwidth becomes narrow, and the antenna gain deteriorates extremely. It is hence difficult to mount the antennas on the ground, which is the basic requirement for realizing incorporation of antenna in a small portable terminal, and directive diversity may not be realized in a small portable terminal. Besides, since the antenna is made of a metal element, it is hard to retain the shape and is likely to be broken.

### SUMMARY OF THE INVENTION

The invention presents an antenna device having a configuration in which a first radiation plate and a second radiation plate of which diameter or one side is about ½ wavelength in electrical length are disposed on a ground plate at an arbitrary interval, a first power feed port and a second power feed port provided on the first radiation plate are disposed so that the straight lines linking each power feed port position and the middle point of the first radiation plate may be orthogonal to each other, a third power feed port and a fourth power feed port provided on the second radiation plate are disposed so that the straight lines linking each power feed port position and the middle point of the second radiation plate may be orthogonal to each other, and the two orthogonal straight lines of the first radiation plate are defined to have an angle of 45 degrees to the two orthogonal straight lines of the second radiation plate.

The invention also presents an antenna device having a configuration in which a first radiation plate and a second radiation plate of which diameter or one side is about ½ wavelength in electrical length are disposed on a ground plate at an arbitrary interval, a first power feed port and a second power feed port provided on the first radiation plate are disposed so that the straight lines linking each power feed port position and the middle point of the first radiation plate may be orthogonal to each other, a third power feed port and a fourth power feed port are disposed also on the second radiation plate in a similar positional relation, and the straight line linking the middle point of the first power feed port and second power feed port and the middle point of the first radiation plate or the straight line orthogonal to this straight line at the middle point of the radiation plate and the straight line linking the middle point of the third power feed port and fourth power feed port and the middle point of the second radiation plate or the straight line orthogonal to this straight line at the middle point of the radiation plate are present on an identical straight line.

The invention further presents an antenna device having a configuration in which a first radiation plate and a second radiation plate of which diameter or one side is about ½ wavelength in electrical length are disposed on a ground plate at an arbitrary interval, a first power feed port and a second power feed port are provided in the peripheral area of the first radiation plate, a first straight line linking the first power feed port provided on the first radiation plate and the middle point of the first radiation plate is orthogonal to a second straight line linking the second power feed port and the middle point of the first radiation plate, a third straight line linking a third power feed port provided on the second radiation plate and the middle point of the second radiation plate is orthogonal to a fourth straight line linking a fourth power feed port provided on the second radiation plate and the middle point of the second radiation plate, the electrical length of the first straight line and the electrical length of the third straight line and the electrical length of the second straight line and the electrical length of the fourth straight line are the identical length, the electrical length of the first straight line and the electrical length of the second straight line are different lengths, and the first straight line and the third straight line or the second straight line and the fourth straight line are present on different lines.

### BRIEF DESCRIPTION OF THE DRAWINGS

FIG. 1A is a perspective view of an antenna device in preferred embodiment 1.

FIG. 1B is a top view of the antenna device of the same.

FIG. 1C is a radiation characteristic diagram of the antenna device of the same.

FIG. 2A is a perspective view of an antenna device in preferred embodiment 2.

FIG. 2B is a top view of the antenna device in preferred embodiment 2.

FIG. 2C is a radiation characteristic diagram of the antenna device in preferred embodiment 2.

FIG. 3A is a perspective view of an antenna device in preferred embodiment 3.

FIG. 3B is a top view of the antenna device in preferred embodiment 3.

FIG. 3C is a radiation characteristic diagram of the antenna device in preferred embodiment 3.

FIG. 4A is a perspective view of an antenna device in preferred embodiment 4.

FIG. 4B is a top view of the antenna device of the same.

FIG. 5A is a perspective view of an antenna device in preferred embodiment 5.

FIG. 5B is a top view of the antenna device in preferred embodiment 5.

FIG. 6A is a perspective view of an antenna device in preferred embodiment 9.

FIG. 6B is a top view of the antenna device of the same.

FIG. 7A is a perspective view of an antenna device in preferred embodiment 10.

FIG. 7B is a top view of the antenna device in preferred embodiment 10.

FIG. 8A is a perspective view of an antenna device in preferred embodiment 11.

FIG. 8B is a top view of the antenna device of the same.

FIG. 9A is a perspective view of an antenna device in preferred embodiment 12.

FIG. 9B is a top view of the antenna device in preferred embodiment 12.

FIG. 10 is a perspective view of an antenna device in preferred embodiment 13.

FIG. 11 is a perspective view of an antenna device in preferred embodiment 14.

FIG. 12 is a perspective view of an antenna device in preferred embodiment 31.

FIG. 13A is a perspective view of an antenna device in preferred embodiment 15.

FIG. 13B is a top view of the antenna device of the same.

FIG. 14A is a perspective view of an antenna device in preferred embodiment 16.

FIG. 14B is a top view of the antenna device in preferred embodiment 16.

FIG. 15A is a perspective view of an antenna device in preferred embodiment 17.

FIG. 15B is a sectional view of the antenna device in preferred embodiment 17.

FIG. 16A is a perspective view of an antenna device in preferred embodiment 18.

FIG. 16B is a top view of the antenna device of the same.

FIG. 17A is a perspective view of an antenna device in preferred embodiment 19.

FIG. 17B is a top view of the antenna device in preferred embodiment 19.

FIG. 18A is a magnified view of an antenna device in preferred embodiment 20.

FIG. 18B is a perspective view of the antenna device of the same.

FIG. 19A is a perspective view of an antenna device in preferred embodiment 21.

FIG. 19B is a perspective view of the antenna device in preferred embodiment 21.

FIG. 20A is a top view of an antenna device in preferred embodiment 22.

FIG. 20B is a top view when the position of the power feeder of the same antenna device is changed.

FIG. 21A is a top view of an antenna device in preferred embodiment 23.

FIG. 21B is a top view when the position of the power feeder of the antenna device in preferred embodiment 23 is changed.

FIG. 22A is a top view of an antenna device in preferred embodiment 24.

FIG. 22B is a top view of the antenna device in preferred embodiment 24.

FIG. 23A is a top view of an antenna device in preferred embodiment 25.

FIG. 23B is a top view when the radiation plate of the same antenna device is changed in a circular shape.

FIG. 24 is a top view of an antenna device in preferred embodiment 26.

FIG. 25A is a top view of an antenna device in preferred embodiment 30.

FIG. 25B is a top view of the antenna device in preferred embodiment 30.

FIG. 26A is a perspective view of an antenna device in preferred embodiment 27, 28 or 29.

FIG. 26B is a perspective view of the second antenna device of the same.

FIG. 27 is a top view of an antenna device in preferred embodiment 6.

FIG. 28 is a top view of an antenna device in preferred embodiment 7.

FIG. 29 is a top view of an antenna device in preferred embodiment 8.

FIG. 30A is a perspective view of an antenna device in a first prior art.

FIG. 30B is a perspective view of an antenna device in a second prior art.

### DESCRIPTION OF THE PREFERRED EMBODIMENTS

Referring now to the drawings, preferred preferred embodiments of the invention are described in detail below.

(Preferred Embodiment 1)

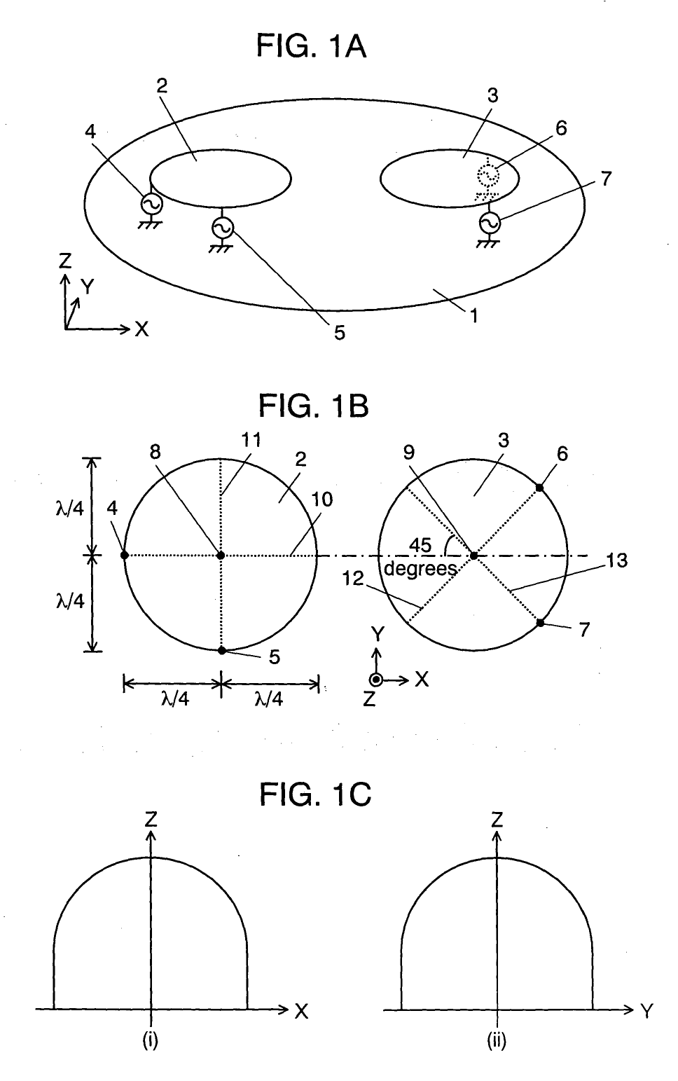

FIG. 1A and FIG. 1B show an antenna device in preferred embodiment 1, in which a first power feed port 4 and a second power feed port 5 are provided in a peripheral area of a circular first radiation plate 2 of which diameter is about half wavelength in electrical length disposed oppositely to a ground plate 1, and a first straight line 10 linking the position of the first power feed port 4 and the middle point 8 of the first radiation plate 2 and a second straight line 11 linking the second power feed port 5 and the middle point 8 of the first radiation plate 2 cross each other at an angle of 90 degrees at the first middle point 8.

Similarly, as for a second radiation plate 3 disposed oppositely to the ground plate 1, closely to the first radiation plate 2, a third power feed port 6 and a fourth power feed port 7 are provided in its peripheral area in the same relation as in the case of the first radiation plate 2. The first radiation plate 2 and second radiation plate 3 are disposed so that a third straight line 12 and a fourth straight line 13 may cross each other at an angle of 45 degrees at the middle point 9 of the second radiation plate 3 when the first straight line 10 is extended.

FIG. 1C shows an upward radiation pattern on the ground plate 1 when power is fed to the first radiation plate 2. Diagram (i) shows a radiation pattern of vertical polarized wave when power is supplied to the first power feed port 4 only. When power is supplied to the first power feed port 4, a vector of resonance current is generated in the direction of the first straight line 10, and an electric field of components parallel to this vector is radiated in a remote place. As a result, electromagnetic waves of vertical polarized wave are radiated only on the XZ plane, and electromagnetic waves of vertical polarized wave are not radiated on the YZ plane.

Therefore, when the second radiation plate 3 is disposed in the X-axis direction, if the maximum gain direction of the second radiation plate 3 is directed in the X-axis direction, the electromagnetic coupling of the first radiation plate 2 and second radiation plate 3 is increased, and favorable effect as diversity antenna cannot be obtained.

Diagram (ii) shows a radiation pattern of vertical polarized wave when power is supplied to the second power feed port 5 only, and according to the same principle as in (i), electromagnetic waves of vertical polarized wave are radiated only on the YZ plane, and electromagnetic waves of vertical polarized wave are not radiated on the XZ plane. Therefore, when the second radiation plate 3 is disposed in the Y-axis direction, it is required to design so that the maximum gain direction of the second radiation plate 3 may not be directed in the Y-axis direction.

Considering these requirements, in order to keep a proper isolation between the first power feed port 4 and second power feed port 5, the second radiation plate is disposed so that the third straight line 12 and fourth straight line 13 of the second radiation plate 3 may form an angle of 45 degrees at an intermediate angle of the X-axis and Y-axis. As a result, the correlation coefficient of power feed ports can be decreased, and an effective diversity antenna having four planes of polarization can be realized.

As an example of use of this antenna device, when the first power feed port 4 and second power feed port 5 of the first radiation plate 2 are used for Bluetooth, and the third power feed port 6 and fourth power feed port 7 of the second radiation plate 3 are used for W-LAN, a polarization diversity antenna module having polarization diversity antennas disposed closely corresponding to each system is realized, or when the first power feed port 4 and third power feed port 6 are used for Bluetooth, and the second power feed port 5 and fourth power feed port 7 are used for W-LAN, a diversity antenna combining the polarization diversity and space diversity corresponding to each system is realized.

As a result, directive diversity antennas of two systems are integrated and reduced in size. For example, it can be used as a diversity antenna for terminal device capable of using Bluetooth and W-LAN simultaneously.

In FIGS. 1A, 1B, 1C, the space among the first radiation plate 2, second radiation plate 3 and ground plate 1 is filled with air, but it may be also composed of a dielectric material, a magnetic material, or a combination material thereof.

According to the invention, the isolation value among power feed ports can be designed at a high level, and hence the correlation coefficient can be suppressed low, and the diversity effect is enhanced, and moreover the first radiation plate and second radiation plate have two polarized waves orthogonal to each other respectively, and by disposing these antennas at a specific spacing, a composite diversity antenna of directive diversity and space diversity having planes of polarization at every 45 degrees is realized, and a favorable communication quality can be maintained even in fading environment.

The shape of the radiation plate is line symmetrical to the straight line linking each power feed port and the middle point of the radiation plate, and TM11 mode is generated between the radiation plate and ground plate, and therefore by disposing the power feed port at the orthogonal position on the radiation plate, isolation between power feed ports is assured, and an effective diversity antenna of low correlation coefficient is realized.

(Preferred Embodiment 2)

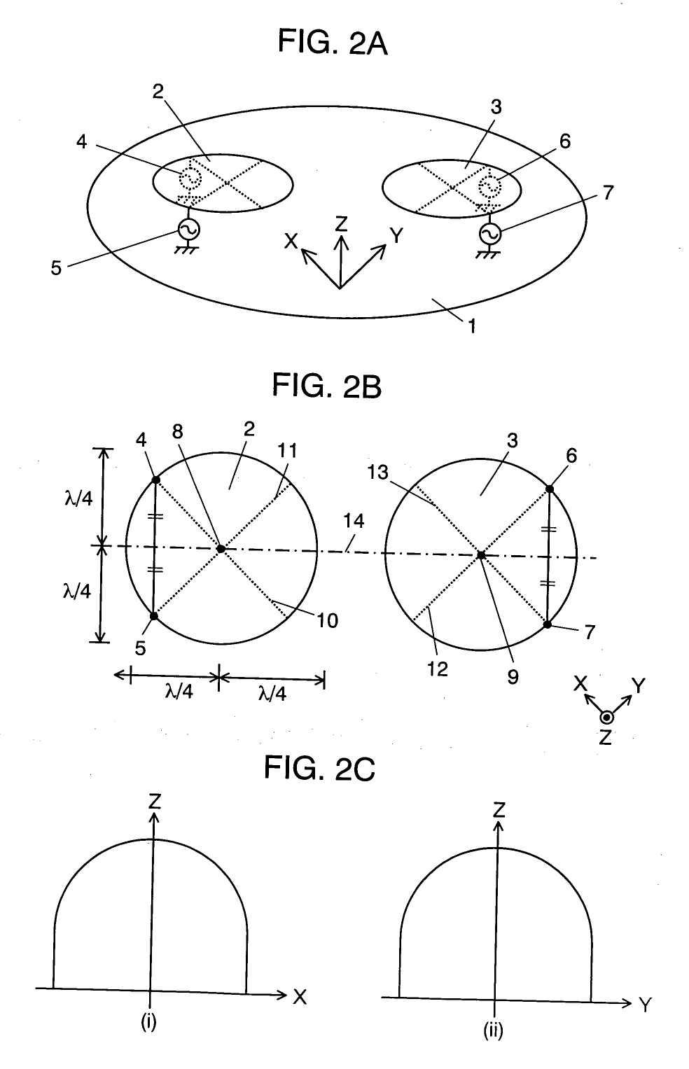

FIG. 2A and FIG. 2B show an antenna device in preferred embodiment 2, in which a first power feed port 4 and a second power feed port 5 are provided in a peripheral area of a circular first radiation plate 2 of which diameter is about half wavelength in electrical length disposed oppositely to a ground plate 1, and a straight line 10 linking the first power feed port 4 and the middle point 8 of the first radiation plate 2 and a second straight line 11 linking the second power feed port 5 and the middle point 8 of the first radiation plate 2 cross each other orthogonally at the middle point 8 of the first radiation plate 2. Similarly, as for a second radiation plate 3 disposed oppositely to the ground plate 1, closely to the first radiation plate 2, a third power feed port 6 and a fourth power feed port 7 are provided in its peripheral area in the same relation as in the case of the first radiation plate 2. The first radiation plate 2 and second radiation plate 3 are disposed so that a fifth straight line 14 linking the middle point of the first power feed port 4 and second power feed point 5 and the middle point 8 of the first radiation plate 2 and a straight line linking the middle point of the third power feed port 6 and fourth power feed point 7 and the middle point 9 of the second radiation plate 3 may coincide with each other.

FIG. 2C shows an upward radiation pattern on the ground plate 1 when power is fed to the first radiation plate 2. Diagram (i) shows a radiation pattern of vertical polarized wave when power is supplied to the first power feed port 4 only. When power is supplied to the first power feed port 4, a vector of resonance current is generated in the direction of the first straight line 10, and an electric field of components parallel to this vector is radiated in a remote place. As a result, electromagnetic waves of vertical polarized wave are radiated only on the XZ plane, and electromagnetic waves of vertical polarized wave are not radiated on the YZ plane. Therefore, when the second radiation plate 3 is disposed in the X-axis direction, if the maximum gain direction of the second radiation plate 3 is directed in the X-axis direction, the electromagnetic coupling of the first radiation plate 2 and second radiation plate 3 is increased, and favorable effect as diversity antenna cannot be obtained.

Diagram (ii) shows a radiation pattern of vertical polarized wave when power is supplied to the second power feed port 5 only, and according to the same principle as in (i), electromagnetic waves of vertical polarized wave are radiated only on the YZ plane, and electromagnetic waves of vertical polarized wave are not radiated on the XZ plane. Therefore, in order that the maximum gain direction when power is supplied to each power feed port of the first radiation plate 2 and the maximum gain direction when power is supplied to each power feed port of the second radiation plate 3 may not coincide oppositely, the first straight line 10, second straight line 11, third straight line 12, and fourth straight line 13 are disposed so as not to be present on an identical line. As a result, the correlation coefficient of power feed ports can be decreased, and an effective diversity antenna having four planes of polarization can be realized.

According to the invention, while maintaining a high isolation value among the power feed ports, the number of branches of antenna can be increased, and even in environments of multiple occurrences of deep attenuation of reception power due to multipath fading, a diversity antenna capable of maintaining a high communication quality can be realized.

Besides, since TM11 mode is generated between the radiation plate and ground plate, by disposing power feed ports at orthogonal positions on the radiation plate, isolation among power feed ports can be assured, and an effective diversity antenna of low correlation coefficient can be realized.

As an example of use of this antenna device, when the first power feed port 4 and second power feed port 5 of the first radiation plate 2 are used for Bluetooth, and the third power feed port 6 and fourth power feed port 7 of the second radiation plate 3 are used for W-LAN, a polarization diversity antenna module having polarization diversity antennas disposed closely corresponding to each system is realized, or when the first power feed port 4 and third power feed port 6 are used for Bluetooth, and the second power feed port 5 and fourth power feed port 7 are used for W-LAN, a diversity antenna combining the polarization diversity and space diversity corresponding to each system is realized.

In FIGS. 2A, 2B, 2C, the space among the first radiation plate 2, second radiation plate 3 and ground plate 1 is filled with air, but it may be also composed of a dielectric material, a magnetic material, or a combination material thereof.

(Preferred Embodiment 3)

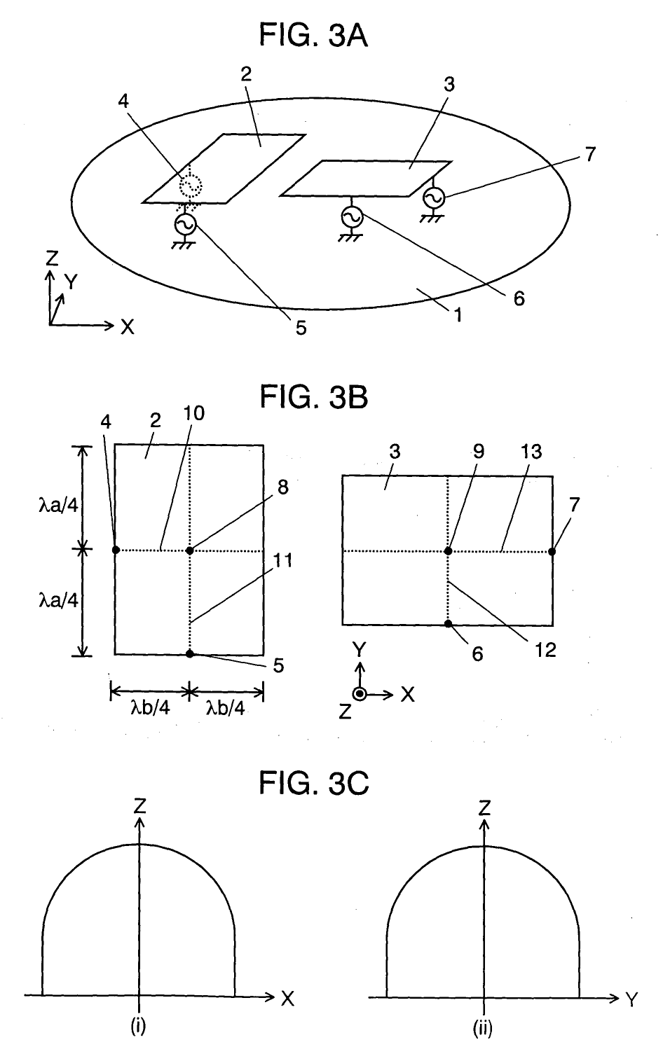

FIG. 3A and FIG. 3B show an antenna device in preferred embodiment 3, in which a first power feed port 4 and a second power feed port 5 are provided in a peripheral area of a rectangular first radiation plate 2 of which one side is about half wavelength in electrical length disposed oppositely to a ground plate 1, and a first straight line 10 linking the position of the first power feed port 4 and a first middle point 8 and a second straight line 11 linking the second power feed port 5 and the first middle point 8 cross each other at an angle of 90 degrees at the first middle point 8. Similarly, as for a second radiation plate 3 disposed oppositely to the ground plate 1, closely to the first radiation plate 2, a third power feed port 6 and a fourth power feed port 7 are provided in its peripheral area in the same relation as in the case of the first radiation plate 2. The first radiation plate 2 and second radiation plate 3 are disposed so that the first straight line 10, when extended, may cross with a third straight line 12 at an angle of 90 degrees, and may not exist on a same straight line.

FIG. 3C shows an upward radiation pattern on the ground plate 1 when power is fed to the first radiation plate 2. Diagram (i) shows a radiation pattern of vertical polarized wave when power is supplied to the first power feed port 4 only. When power is supplied to the first power feed port 4, a vector of resonance current is generated in the direction of the first straight line 10, and an electric field of components parallel to this vector is radiated in a remote place. As a result, electromagnetic waves of vertical polarized wave are radiated only on the XZ plane, and electromagnetic waves of vertical polarized wave are not radiated on the YZ plane. Therefore, when the second radiation plate 3 of same resonance frequency is disposed in the X-axis direction, if the maximum gain direction of the second radiation plate 3 is directed in the X-axis direction, the electromagnetic coupling of the first radiation plate 2 and second radiation plate 3 is increased, and favorable effect as diversity antenna cannot be obtained.

Diagram (ii) shows a radiation pattern of vertical polarized wave when power is supplied to the second power feed port 5 only, and according to the same principle as in (i), electromagnetic waves of vertical polarized wave are radiated only on the YZ plane, and electromagnetic waves of vertical polarized wave are not radiated on the XZ plane. Therefore, when disposing the second radiation plate 3 in the Y-axis direction, it must be designed so that the maximum gain direction of the second radiation plate 3 having the same resonance frequency may not be directed in the Y-axis direction.

Considering these requirements, by defining the maximum gain directions orthogonal when power is supplied to the first power feed port 4 and third power feed port 6 having the same resonance frequency, and assuring isolation between the both power feed ports, the correlation coefficient between the power feed ports can be decreased, and an effective diversity antenna can be realized.

Further, since one antenna has two power feed ports of different resonance frequencies of assured isolation, the number of necessary antennas can be reduced generally to a half, and the cost and space of installation can be saved.

As an example of use of this antenna device, when the first power feed port 4 of the first radiation plate 2 and the third power feed port 6 of the second radiation plate 3 are used for GSM system, and the second power feed port 5 of the first radiation plate 2 and the fourth power feed port 7 of the second radiation plate 3 are used for DCS system, a diversity antenna combining the polarization diversity and space diversity corresponding to the two systems is realized, or when the first power feed port 4 and second power feed port 5 are used for GSM transmission system, and the third power feed port 6 and fourth power feed port 7 are used for GSM reception system, a diversity antenna combining the polarization diversity and space diversity corresponding to one system is realized.

In FIGS. 3A, 3B, 3C, the space among the first radiation plate 2, second radiation plate 3 and ground plate 1 is filled with air, but it may be also composed of a dielectric material, a magnetic material, or a combination material thereof.

(Preferred Embodiment 4)

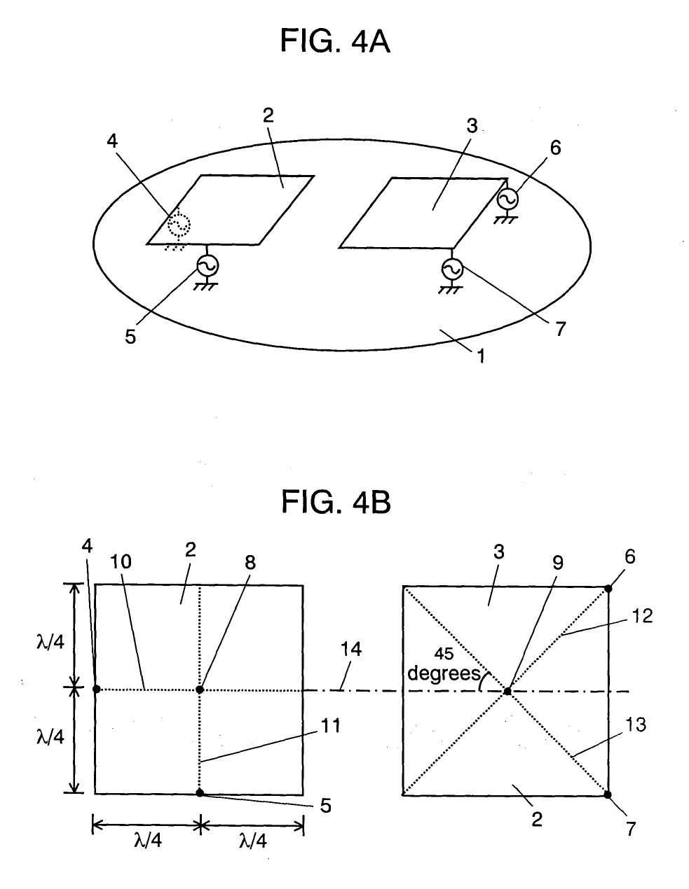

FIG. 4A and FIG. 4B show an antenna device in preferred embodiment 4, and preferred embodiment 4 is similar to preferred embodiment 1, except that the shape of the radiation plate is changed from circular shape to square shape. Whether in circular shape or in square shape, the shape is symmetrical to the straight lines linking the power feed ports and the middle point of radiation plate, and both have similar characteristics. Moreover, if the size of the radiation plate is reduced by forming slits in the peripheral area of the radiation plate so as to be symmetrical to the straight lines linking the power feed ports and the middle point of radiation plate, same effects as the antenna device in preferred embodiment 1 are obtained.

(Preferred Embodiment 5)

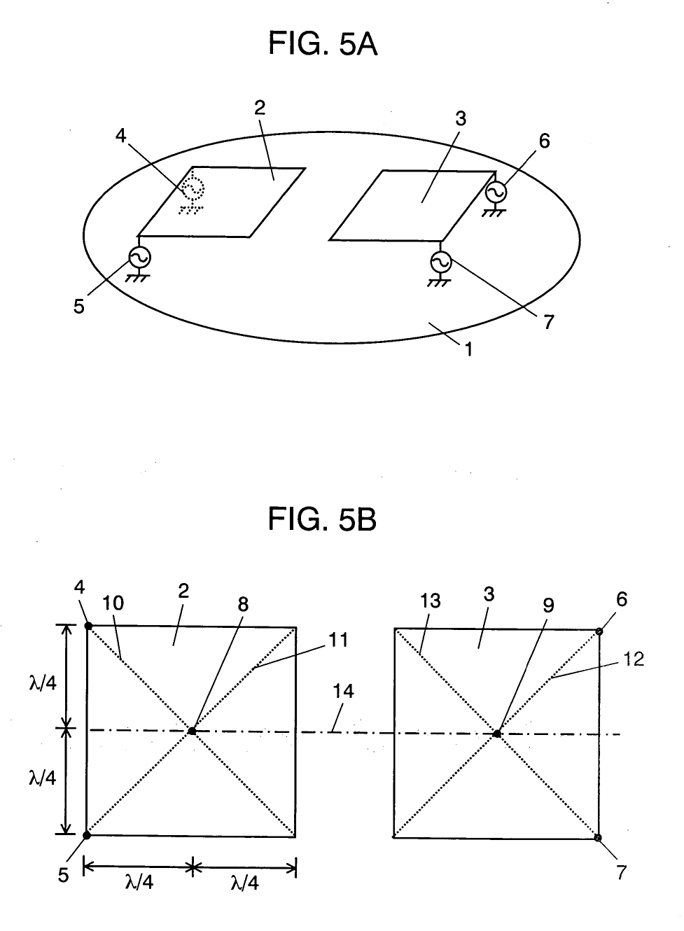

FIG. 5A and FIG. 5B show an antenna device in preferred embodiment 5, and preferred embodiment 5 is similar to preferred embodiment 2, except that the shape of the radiation plates 2, 3 is changed from circular shape to square shape.

Same effects as in preferred embodiment 4 are obtained.

(Preferred Embodiment 6)

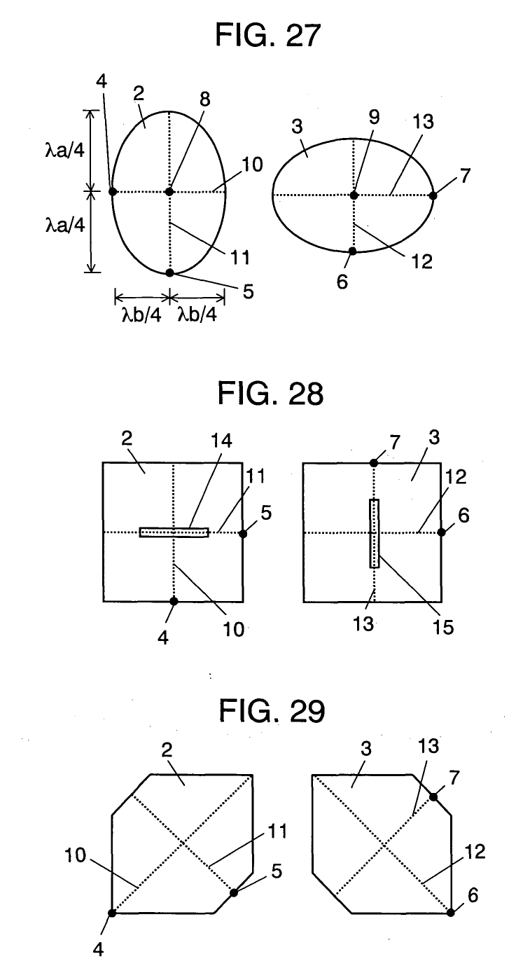

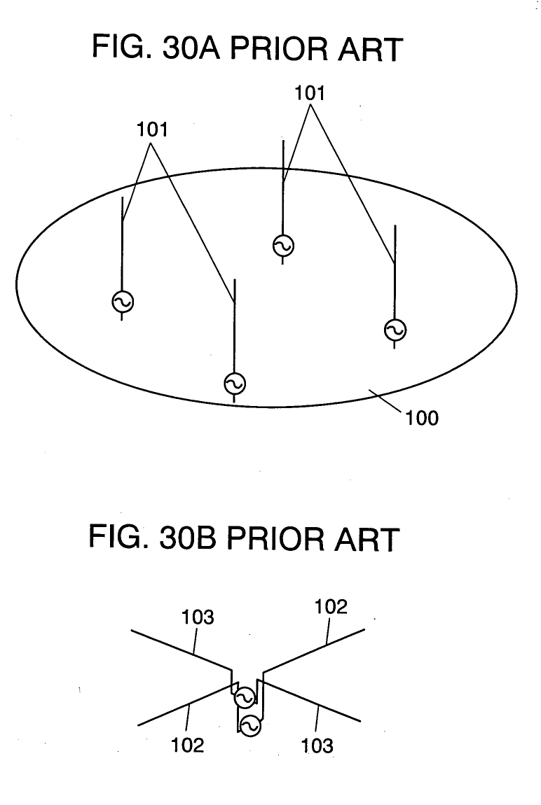

FIG. 27 shows an antenna device in preferred embodiment 6, in which the shape of the radiation plates 2, 3 in preferred embodiment 3 is changed from rectangular shape to elliptical shape.

Same effects as in preferred embodiment 4 are obtained.

(Preferred Embodiment 7)

FIG. 28 shows an antenna device in preferred embodiment 7, in which a first slit 14 is provided in the middle of a nearly square first radiation plate 2, and a second slit 15 is provided in the middle of a second radiation plate 3, and therefore a first straight line 10 in a flowing direction of resonance current when power is supplied to a first power feed port 4 is disturbed by the first slit 14, and the resonance current flows while turning around the side of the first slit 14, so that the resonance frequency of the first power feed port 4 is lower than the resonance frequency of the second power feed port 5. As a result, although the shape of the radiation plates 2, 3 is square shape, same effects as in preferred embodiment 3 are obtained.

(Preferred Embodiment 8)

FIG. 29 shows an antenna device in preferred embodiment 8, in which two corners of radiation plates symmetrical to the middle point of the nearly square first and second radiation plates 2, 3 are cut off, and hence the electrical length is different between a first straight line 10 and a second straight line 11, and between a third straight line 12 and a fourth straight line 13, so that same effects as in preferred embodiment 3 are obtained.

(Preferred Embodiment 9)

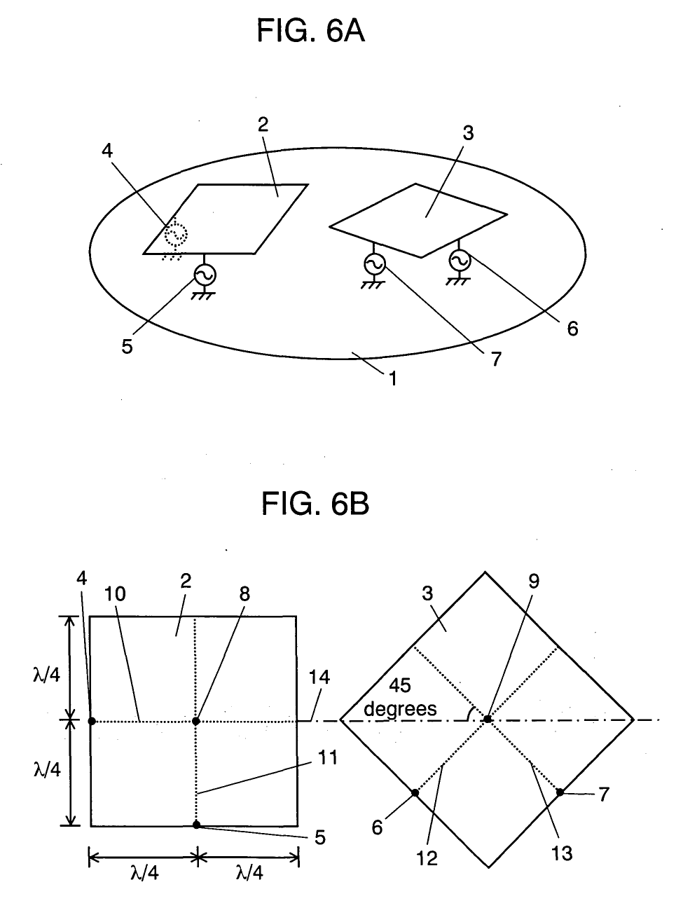

FIG. 6A and FIG. 6B show an antenna device in preferred embodiment 9, and preferred embodiment 9 is similar to preferred embodiment 4, except that the positions of power feed ports 6, 7 of the second radiation plate 3 are changed from corners of the square to the middle of the end sides. To match the configuration of a first straight line 10, a second straight line 11, a third straight line 12, and a fourth straight line 13 with that of preferred embodiment 4, the second radiation plate 3 is disposed by inclining 45 degrees to the first radiation plate 2.

(Preferred Embodiment 10)

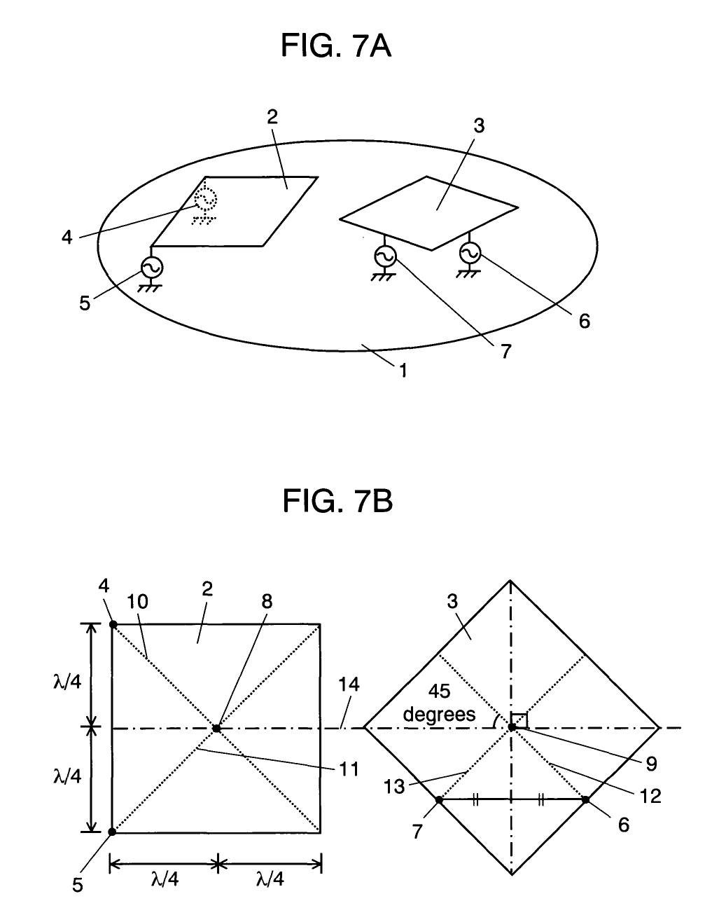

FIG. 7A and FIG. 7B show an antenna device in preferred embodiment 10, and preferred embodiment 10 is similar to preferred embodiment 5, except that the positions of power feed ports 6, 7 of the second radiation plate 3 are changed from corners of the square to the middle of the end sides. To match the configuration of a first straight line 10, a second straight line 11, a third straight line 12, and a fourth straight line 13 with that of preferred embodiment 5, the second radiation plate 3 is disposed by inclining 45 degrees to the first radiation plate 2.

(Preferred Embodiment 11)

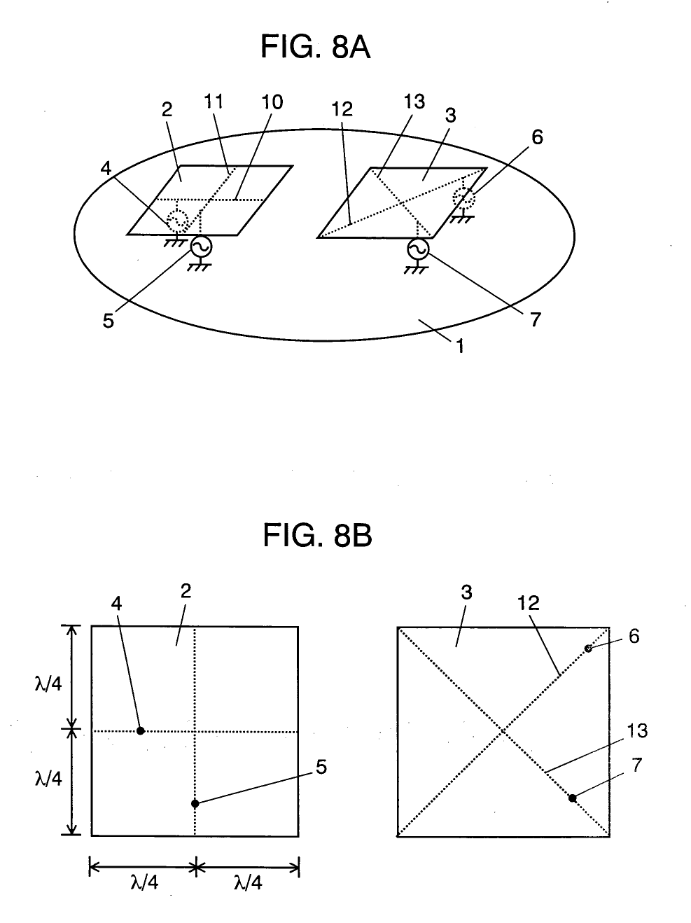

FIG. 8A and FIG. 8B show an antenna device in preferred embodiment 11, and preferred embodiment 11 is similar to preferred embodiment 9, except that the positions of power feed ports are changed from end portions of the radiation plates 2, 3 to positions on a straight line linking the power feed ports other than the end portions of the radiation plates 2, 3 and the middle point of the radiation plate. By finding the power feed position matched on the straight line linking the power feed ports other than the end portions of the radiation plates 2, 3 and the middle point of the radiation plate, power can be supplied without requiring matching circuit, and the matching elements are curtailed and the space for mounting matching elements can be saved.

(Preferred Embodiment 12)

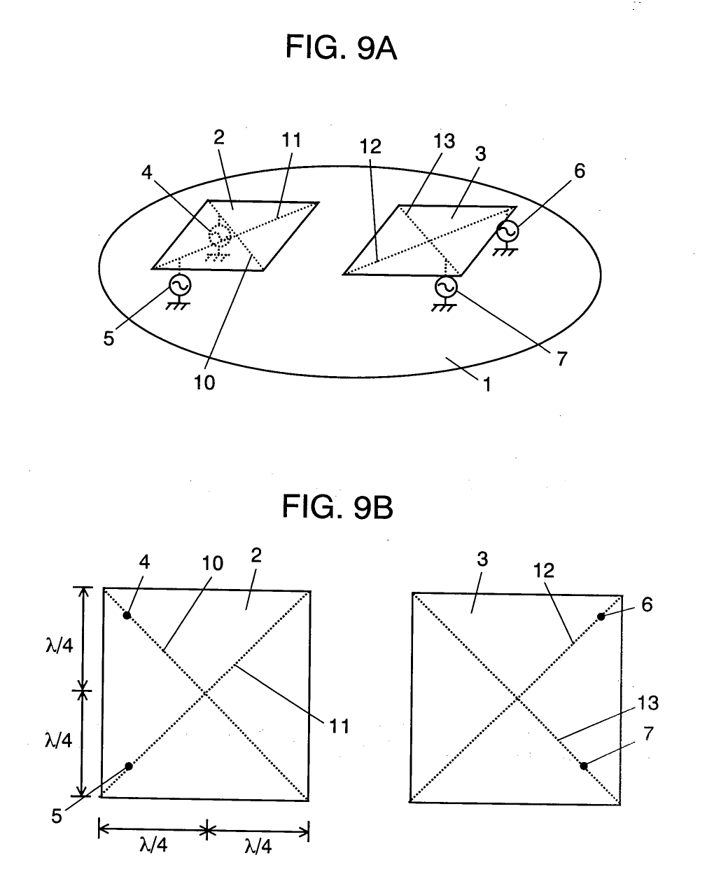

FIG. 9A and FIG. 9B show an antenna device in preferred embodiment 12, and preferred embodiment 12 is similar to preferred embodiment 10, except that the positions of power feed ports 4 to 7 are changed from end portions of radiation plates 2, 3 to positions on a straight line linking the power feed ports other than the end portions of the radiation plates 2, 3 and the middle point of the radiation plates 2, 3.

Same effects as in preferred embodiment 11 are obtained.

(Preferred Embodiment 13)

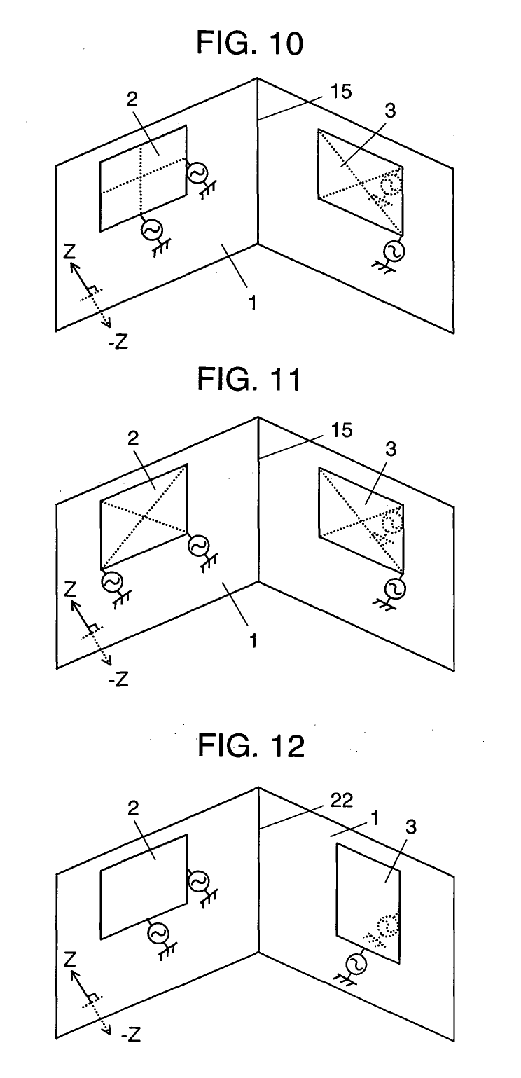

FIG. 10 shows an antenna device in preferred embodiment 13, and preferred embodiment 13 has a structure in which the ground plate 1 is bent by a ground flexure 15 between a first radiation plate 2 and a second radiation plate 3. Since the radiation gain of the first radiation plate 2 in the −Z direction is small, according to preferred embodiment 13 in which the second radiation plate 3 is disposed in the −Z direction on a horizontal plane of the ground plate 1 opposite to the first radiation plate 2, the isolation between the ports can be further increased, and the effects of the diversity antenna can be enhanced. In preferred embodiment 13, the radiation plates are formed in square shape, but same effects are obtained in radiation plates in circular shape.

(Preferred Embodiment 14)

FIG. 11 shows an antenna device in preferred embodiment 14, and preferred embodiment 14 has a structure in which the ground plate 1 is bent by a ground flexure 15 between a first radiation plate 2 and a second radiation plate 3.

Same effects as in preferred embodiment 14 are obtained.

(Preferred Embodiment 15)

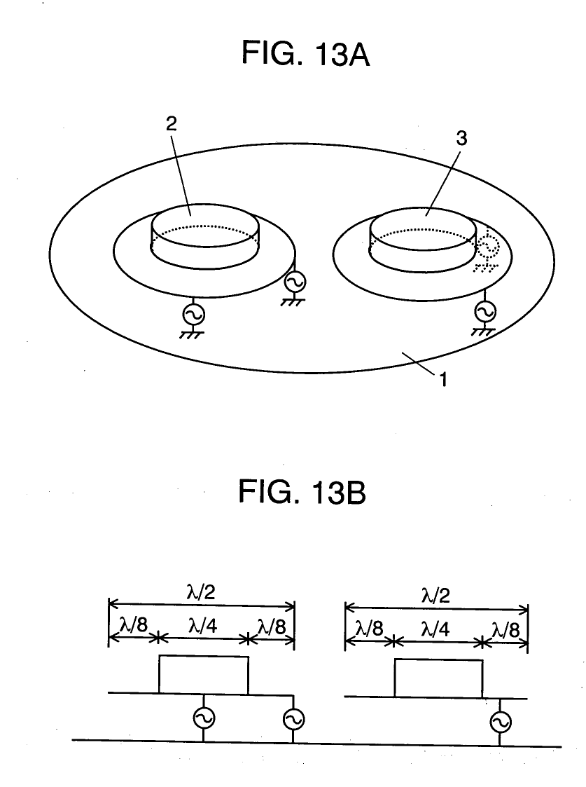

FIG. 13A and FIG. 13B show an antenna device in preferred embodiment 15, and in FIGS. 13A, 13B, the shape of first radiation plate 2 and second radiation plate 3 is convex shape so that the interval from the ground plate 1 to the radiation plates 2, 3 in a region of about ⅛ wavelength in electrical length from the end portion of the radiation plate may be narrower than the interval from the ground plate 1 to the first radiation plate 2 and second radiation plate 3 in other region on the radiation plate. In such structure, the size of the radiation plate can be reduced according to the principle of the resonator having SIR structure (stepped impedance resonator), and a space diversity antenna can be realized while saving the space. In preferred embodiment 15, the radiation plates 2, 3 are formed in convex shape, but same effects are obtained by forming the ground plate 1 in concave shape.

(Preferred Embodiment 16)

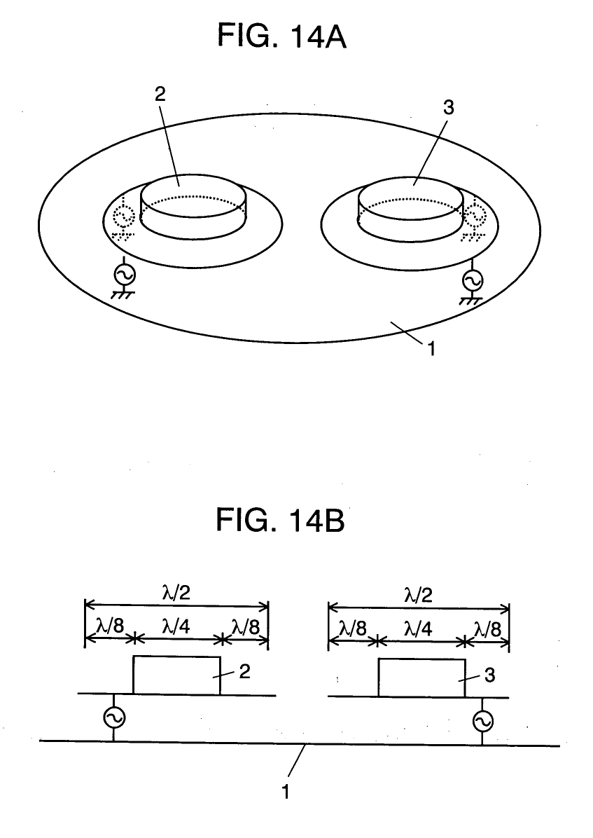

FIG. 14A and FIG. 14B show an antenna device in preferred embodiment 16, and in FIGS. 14A, 14B, the shape of first radiation plate 2 and second radiation plate 3 is convex shape so that the interval from the ground plate 1 to the radiation plates in a region of about ⅛ wavelength in electrical length from the end portion of the radiation plate may be narrower than the interval from the ground plate 1 to the first radiation plates in other region on the radiation plate.

Same effects as in preferred embodiment 15 are obtained.

(Preferred Embodiment 17)

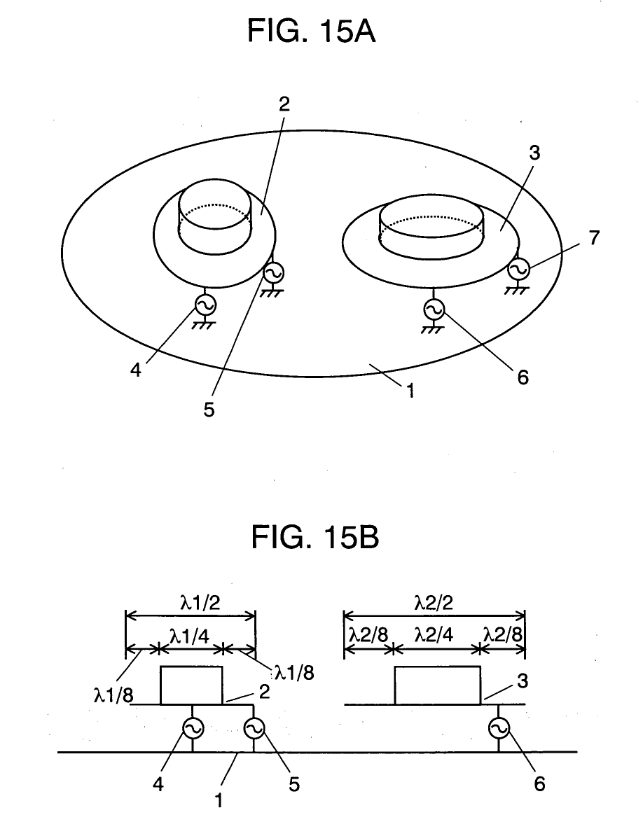

FIG. 15A and FIG. 15B show an antenna device in preferred embodiment 17, and in FIGS. 15A, 15B, the shape of first radiation plate 2 and second radiation plate 3 is convex shape so that the interval from the ground plate 1 to the radiation plates 2, 3 in a region of about ⅛ wavelength in electrical length from the end portion of the radiation plate may be narrower than the interval from the ground plate 1 to the first radiation plate 2 and second radiation plate 3 in other region on the radiation plate, on a straight line linking the position of each power feed port and the middle point of the radiation plate. In such structure, the size of the radiation plates 2, 3 can be reduced according to the principle of the resonator of SIR structure, and a space diversity antenna can be realized while saving the space.

In preferred embodiment 17, the radiation plates 2, 3 are formed in convex shape, but same effects are obtained by forming the ground plate 1 in concave shape. In FIGS. 15A, 15B, the space among the first radiation plate 2, second radiation plate 3 and ground plate 1 is filled with air, but it may be also composed of a dielectric material, a magnetic material, or a combination material thereof.

(Preferred Embodiment 18)

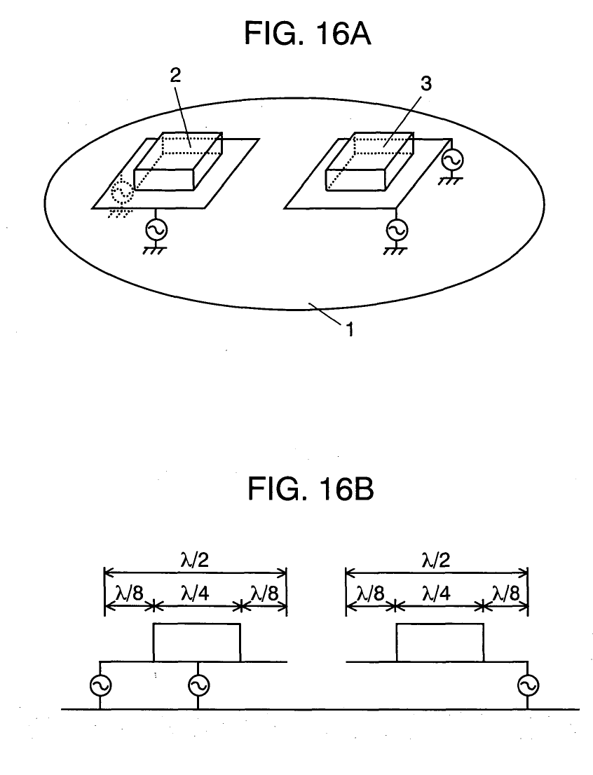

FIG. 16A and FIG. 16B show an antenna device in preferred embodiment 18, and preferred embodiment 18 is similar to preferred embodiment 15, except that the shape of radiation plates 2, 3 is changed from circular shape to square shape. Both circular shape and square shape are symmetrical to the straight lines linking the power feed ports and the middle point of the radiation plates 2, 3, and both have similar characteristics.

(Preferred Embodiment 19)

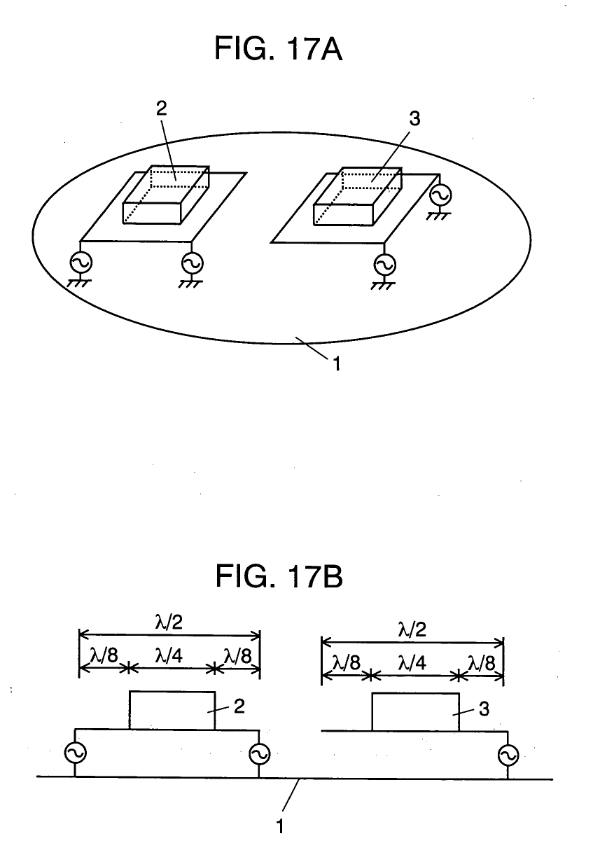

FIG. 17A and FIG. 17B show an antenna device in preferred embodiment 19, and preferred embodiment 19 is similar to preferred embodiment 16, except that the shape of radiation plates 2, 3 is changed from circular shape to square shape. Both circular shape and square shape are symmetrical to the straight lines linking the power feed ports and the middle point of the radiation plates, and both have similar characteristics.

(Preferred Embodiment 20)

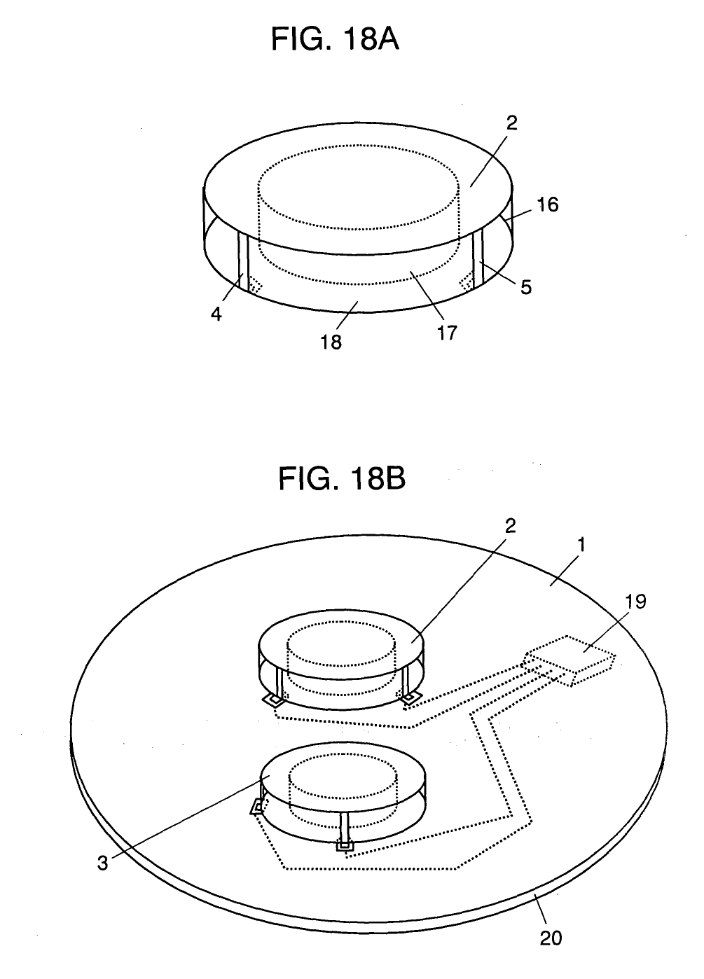

FIG. 18A and FIG. 18B show an antenna device in preferred embodiment 20, and in FIG. 18A, an electrical length of about ⅛ wavelength from the end portion of the first radiation plate 2 is composed of a first base element 16, and other region is composed of a second base element 17, and the first radiation plate 2 is provided on the top of the first base element 16 and second base element 17, and a ground pattern 18 is provided on the bottom of the first base element 16 and second base element 17, while a first power feed port 4 and a second power feed port 5 are provided at the side of the first base element 16.

What must be noted here is that the materials should be selected so that the value of dividing the relative permeability by the dielectric constant of the first base element 16 be smaller than the value of the second base element 17. When the antenna device is composed of the first base element 16 and second base element 17 assuring such relation, the size of the radiation plate can be reduced by the principle of the resonator of SIR structure.

FIG. 18B shows an preferred embodiment of diversity antenna using the antenna shown in FIG. 18A. The antenna shown in FIG. 18A is mounted on the ground plate 1 so as to satisfy the configuration shown in preferred embodiment 4, and power is supplied from a high frequency circuit 19 to each power feed port by way of strip lines and through-holes in the back of a mounting board 20.

(Preferred Embodiment 21)

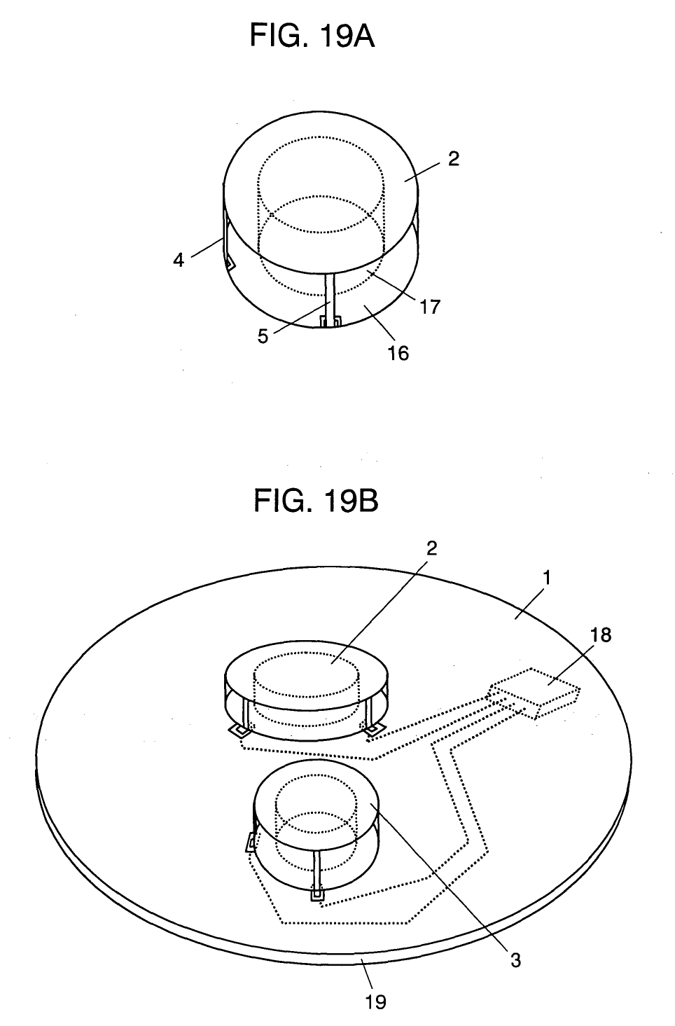

FIG. 19A and FIG. 19B show an antenna device in preferred embodiment 21, and in FIG. 19A, on a straight line linking power feed ports 4, 5 and the middle point of first radiation plate 2, an electrical length of about ⅛ wavelength from the end portion of the first radiation plate 2 is composed of a first base element 16, and other region is composed of a second base element 17, and the first radiation plate 2 is provided on the top of the first base element 16 and second base element 17, and a ground pattern 18 is provided on the bottom of the first base element 16 and second base element 17, while the first power feed port 4 and second power feed port 5 are provided at the side of the first base element 16.

Same effects as in preferred embodiment 20 are obtained.

(Preferred Embodiment 22)

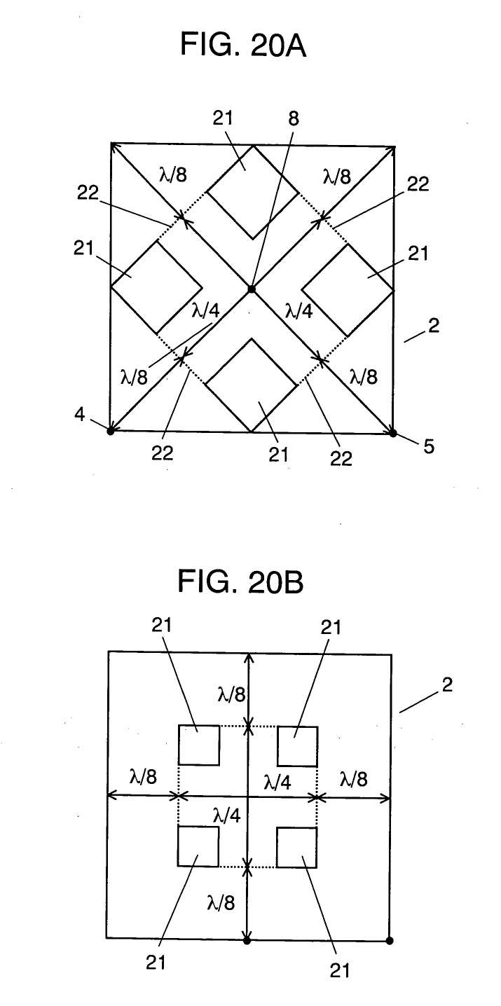

FIG. 20A and FIG. 20B show an antenna device in preferred embodiment 22, and in FIG. 20A, foursquare slits 21 are provided in a first radiation plate 2 so as to be line symmetrical to a first straight line 10 and a second straight line 11 linking a first power feed port 4 and a second power feed port 5 and a first middle point 8, and a sixth straight line 22 orthogonal to each straight line at a position of about ⅛ wavelength in electrical length from the end portion of the first radiation plate 2 and two sides of the four square slits 21 contact with each other on the first straight line 10 and second straight line 11.

Having such structure, since the line width of the region of ⅛ wavelength from the end portion of the radiation plate can be designed wider as compared with other region, the capacity value between the ground plate and radiation plate can be increased, and the characteristic impedance in this region can be set low. On the other hand, since the line width in other than the region of ⅛ wavelength from the end portion of the radiation plate is narrow, and the capacity value between the ground plate and radiation plate is small, and the inductance value is larger, so that the characteristic impedance can be set larger. That is, since the characteristic impedance can be varied largely at a point of ⅛ wavelength from the end portion of the radiation plate, the size of the radiation plate can be reduced according to the principle of the resonator of SIR structure.

FIG. 20B shows the shape of the radiation plate when the positions of the power feed ports in FIG. 20A are changed from the corners of the square of the radiation plate 2 to the middle of end sides. In FIGS. 20A and 20B, the radiation plate of square shape is explained, but same effects are obtained by the radiation plate 2 of circular shape.

(Preferred Embodiment 23)

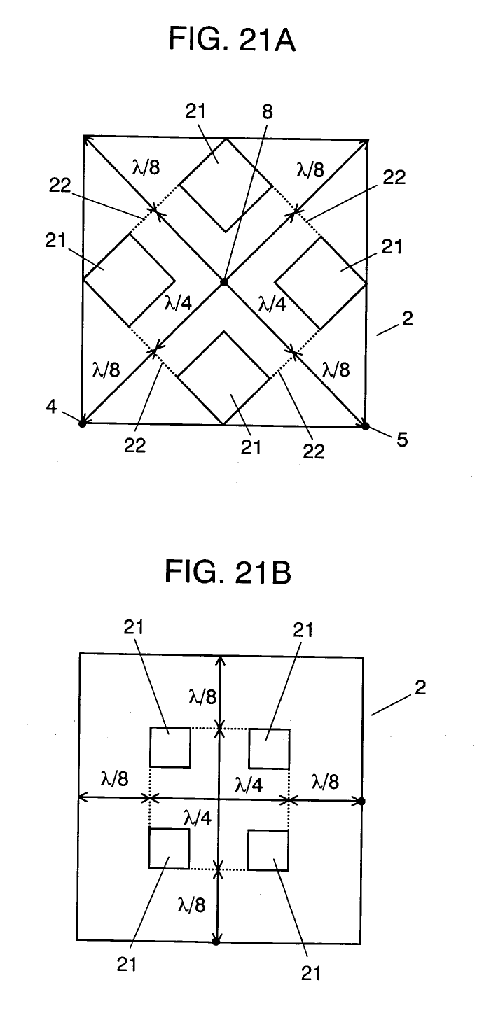

FIG. 21A and FIG. 21B show an antenna device in preferred embodiment 23, and in FIG. 21A, four square slits 21 are provided in a first radiation plate 2 so as to be line symmetrical to a first straight line 10 and a second straight line 11 linking a first power feed port 4 and a second power feed port 5 and a first middle point 8, and a sixth straight line 22 orthogonal to each straight line at a position of about ⅛ wavelength in electrical length from the end portion of the first radiation plate 2 and two sides of the four square slits 21 contact with each other on the first straight line 10 and second straight line 11. Since the line width along the first straight line 10 and second straight line 11 varies largely at a point of ⅛ wavelength from the end portion of the radiation plate, the size of the radiation plate can be reduced according to the principle of the resonator of SIR structure.

FIG. 21B shows the shape of the radiation plate when the positions of the power feed ports in FIG. 21A are changed from the corners of the square of the radiation plate 2 to the middle of end sides. In FIGS. 21A and 21B, the radiation plate 2 of square shape is explained, but same effects are obtained by the radiation plate of circular shape.

(Preferred Embodiment 24)

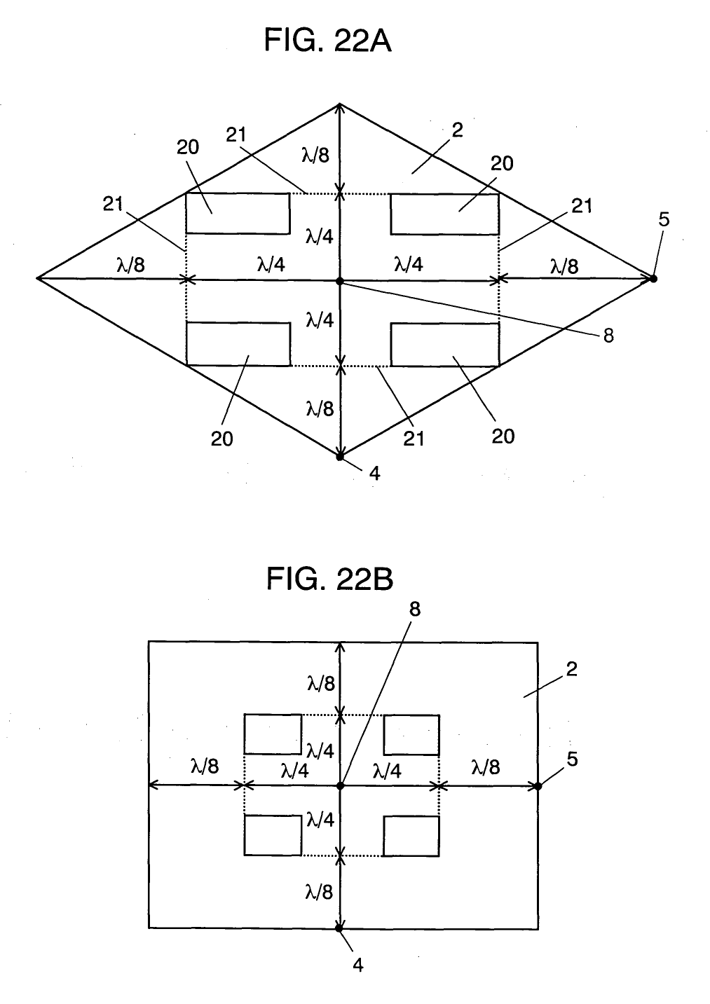

FIG. 22A and FIG. 22B show an antenna device in preferred embodiment 24, and in FIG. 22A, four square slits 20 are provided in a first radiation plate 2 so as to be line symmetrical to a first straight line 10 and a second straight line 11 linking a first power feed port 4 and a second power feed port 5 and a first middle point 8, and a fifth straight line 22 orthogonal to each straight line at a position of about ⅛ wavelength in electrical length from the end portion of the first radiation plate 2 and two sides of the four square slits 20 contact with each other on the first straight line 10 and second straight line 11.

Same effects as in preferred embodiment 23 are obtained.

(Preferred Embodiment 25)

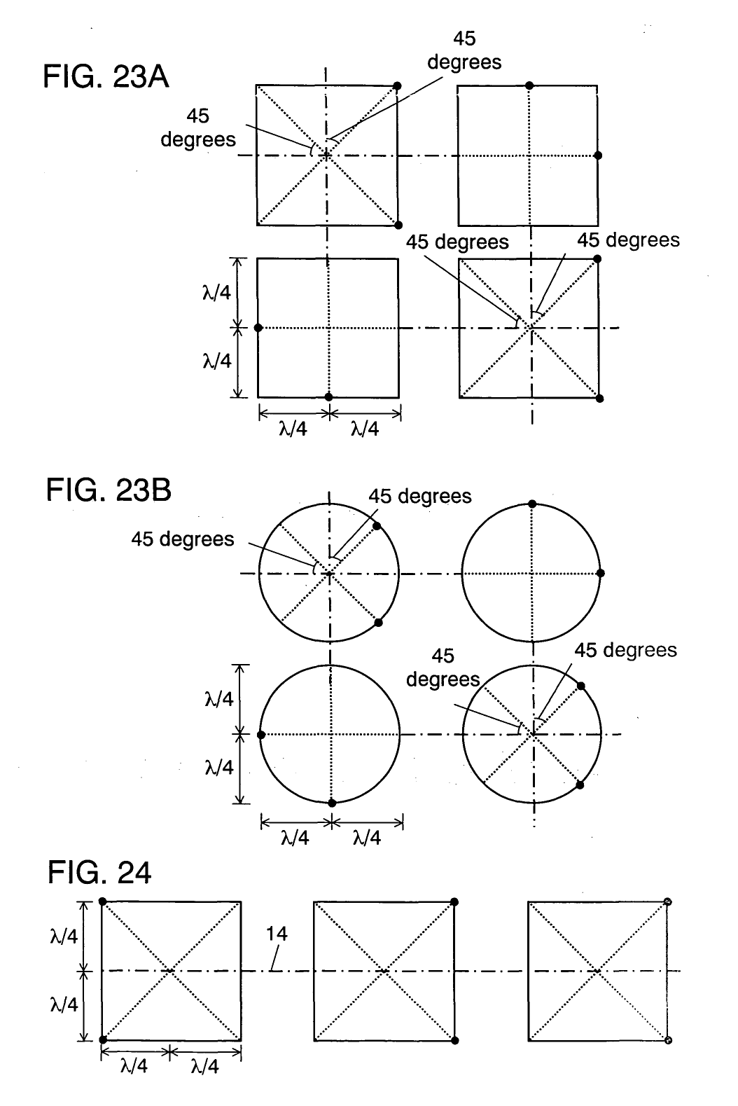

FIG. 23A and FIG. 23B show an antenna device in preferred embodiment 25, and FIG. 23A shows the number of radiation plates is increased from two to four while maintaining the configuration of the first straight line 10, second straight line 11, third straight line 12 and fourth straight line 13 same shown in preferred embodiment 4 in the adjacent radiation plates. Also, while maintaining the configuration of straight lines in preferred embodiment 9, a diversity antenna can be realized by using five or more radiation plates. FIG. 23B shows the shape of radiation plates in FIG. 23A is changed from square shape to circular shape, and same effects as in FIG. 23A are obtained.

(Preferred Embodiment 26)

FIG. 24 shows an antenna device in preferred embodiment 26, and FIG. 24 shows a diversity antenna having radiation plates arranged so that the middle point of two power feed ports of each radiation plate and a fifth straight line 14 linking the middle point of radiation plate may be present on a same straight line, and the isolation between power feed ports can be enhanced same as in preferred embodiment 5. In preferred embodiment 26, the antenna device is composed of radiation plates of square shape, but same effects are obtained by using radiation plates of circular shape.

(Preferred Embodiment 27)

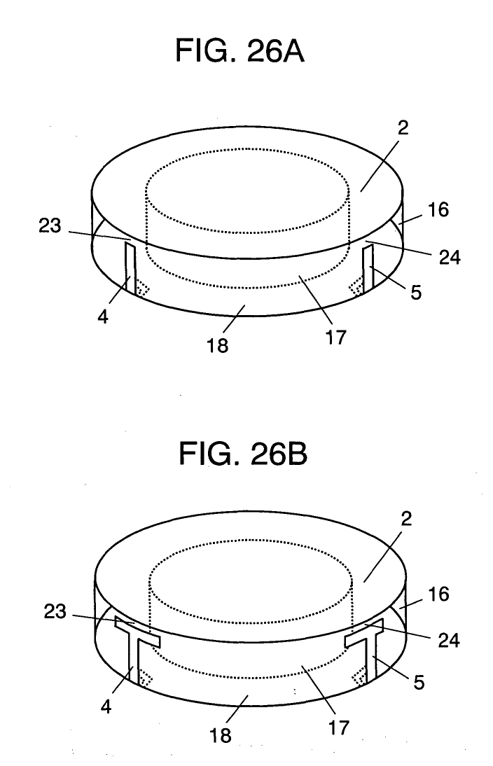

FIG. 26A and FIG. 26B show an antenna device in preferred embodiment 27, and FIG. 26A shows a first gap 23 and a second gap 24 are provided in the first power feed port 4, second power feed port 5 and first radiation plate 2 of the antenna device shown in preferred embodiment 20. By adjusting the gap width of the first gap 23 and second gap 24, the impedance of the first power feed port 4 and second power feed port 5 can be matched, and matching circuit is not needed, and hence the cost is saved, the size is reduced, and a high gain is obtained. Besides, as shown in FIG. 26B, by extending the lateral width of the first gap 23 and second gap 24, the generated capacity value is increased by the gaps, so that the impedance adjustment range can be widened.

(Preferred Embodiment 28)

FIG. 26A and FIG. 26B show an antenna device in preferred embodiment 28, and FIG. 26A shows a first gap 23 and a second gap 24 are provided in the first power feed port 4, second power feed port 5 and first radiation plate 2 of the antenna device shown in preferred embodiment 20.

Same effects as in preferred embodiment 27 are obtained.

(Preferred Embodiment 29)

FIG. 26A and FIG. 26B show an antenna device in preferred embodiment 29, and FIG. 26A shows a first gap 23 and a second gap 24 are provided in the first power feed port 4, second power feed port 5 and first radiation plate 2 of the antenna device of preferred embodiment 21 shown in FIG. 19A.

Same effects as in preferred embodiment 27 are obtained.

(Preferred Embodiment 30)

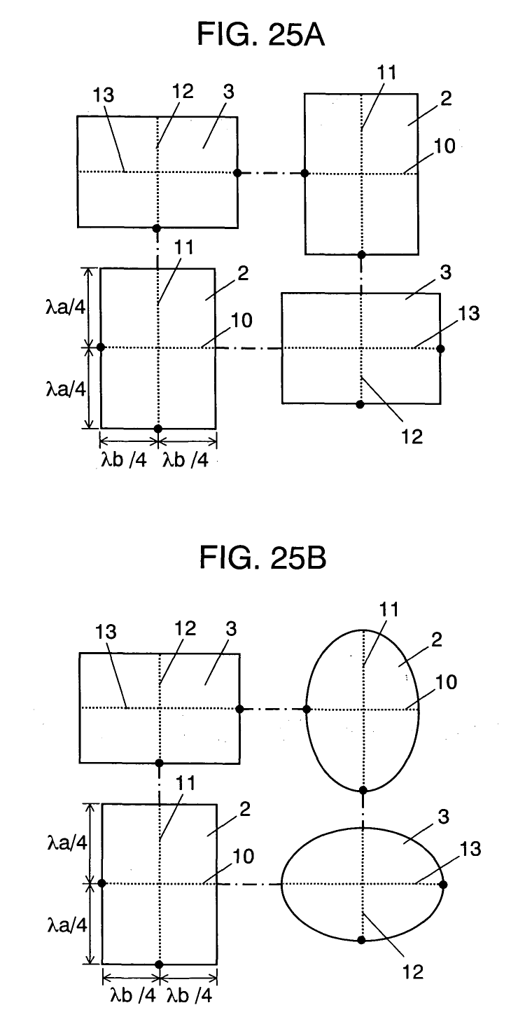

FIG. 25A and FIG. 25B show an antenna device in preferred embodiment 30, and FIG. 25A shows the number of radiation plates is increased from two to four while maintaining the configuration of the first straight line 10, second straight line 11, third straight line 12 and fourth straight line 13 same shown in preferred embodiment 3 in the adjacent radiation plates 2, 3. Also, while maintaining the same configuration, a diversity antenna can be realized by using five or more radiation plates. FIG. 25B shows the shape of radiation plates in FIG. 25A is changed from rectangular shape to elliptical shape, and same effects as in FIG. 25A are obtained.

(Preferred Embodiment 31)

FIG. 12 shows an antenna device in preferred embodiment 31, and preferred embodiment 31 has a structure in which the ground plate 1 is bent by a ground flexure 22 between a first radiation plate 2 and a second radiation plate 3. Since the radiation gain of the first radiation plate 2 in the −Z direction is small, according to preferred embodiment 31 in which the second radiation plate 3 is disposed in the −Z direction on a horizontal plane of the ground plate 1 opposite to the first radiation plate 2, the isolation between the ports can be further increased, and the effects of the diversity antenna can be enhanced. In preferred embodiment 31, the radiation plates are formed in rectangular shape, but same effects are obtained in radiation plates in elliptical shape.

Thus, according to the invention, by effectively disposing plural antennas having two power feed ports of assured isolation, an antenna device of small size and great diversity effect can be realized.

What is claimed is:

1. An antenna device wherein a first radiation plate and a second radiation plate of which diameter or one side is about ½ wavelength in electrical length are disposed on a ground plate at an arbitrary interval, a first power feed port and a second power feed port provided on the first radiation plate are disposed so that the straight lines linking each power feed port position and the middle point of the first radiation plate may be orthogonal to each other, a third power feed port and a fourth power feed port provided on the second radiation plate are disposed so that the straight lines linking each power feed port position and the middle point of the second radiation plate may be orthogonal to each other, and the two orthogonal straight lines of the first radiation plate are defined to have an angle of 45 degrees to the two orthogonal straight lines of the second radiation plate.

2. The antenna device of claim 1, wherein the first and second radiation plates are formed as nearly circular radiation plates of about ½ wavelength in electrical length.

3. The antenna device of claim 1, wherein the first and second radiation plates are formed as nearly square radiation plates of which one side or diagonal length is about ½ wavelength in electrical length.

4. The antenna device of claim 1, wherein the ground plate is folded so that an arbitrary straight line between the adjacent first and second radiation plates forms like a hill top.

5. The antenna device of claim 1, wherein the interval from the ground plate to the first and second radiation plates in a region of about ⅛ wavelength in electrical length from the end portions of the first and second radiation plates is narrower than the interval from the ground plate to the first and second radiation plates in other region on the radiation plates.

6. The antenna device of claim 1, wherein the value of dividing the relative permeability by the dielectric constant of a base element between the ground plate and the first and second radiation plate in a region of about ⅛ wavelength in electrical length from the end portions of the first and second radiation plates is smaller than the value of dividing the relative permeability by the dielectric constant of a base element between the ground plate and the radiation plates in other region on the first and second radiation plates.

7. The antenna device of claim 1, wherein four square slits line symmetrical to each straight line linking each power feed port and the middle point of the first and second radiation plates are provided in the radiation plates, and each orthogonal straight line orthogonal to each straight line and two sides of four square slits contact with each other at positions of about ⅛ wavelength in electrical length from the end portions of the first and second radiation plates on each straight line.

8. The antenna device of claim 1, wherein the first power feed port and second power feed port are used in a first system, and the third power feed port and fourth power feed power are used in a second system.

9. The antenna device of claim 1, wherein the first power feed port and third power feed port are used in a first system, and the second power feed port and fourth power feed power are used in a second system.

10. The antenna device of claim 1, wherein each power feed port is connected to the first and second radiation plates by way of gaps.

11. The antenna device of claim 1, wherein three or more radiation plates of which diameter or one side is about ½ wavelength in electrical length are disposed on the ground plate at a specific interval, two power feed ports provided in each radiation plate are disposed so as to cross each other orthogonally between the position of each power feed port and the straight line linking the middle point of the radiation plates, and the power feed port positions of adjacent radiation plates and the straight line linking the middle point of the radiation plates may have an angle of 45 degrees from each other.

12. An antenna device wherein a first radiation plate and a second radiation plate of which diameter or one side is about ½ wavelength in electrical length are disposed on a ground plate at an arbitrary interval, a first power feed port and a second power feed port provided on the first radiation plate are disposed so that the straight lines linking each power feed port position and the middle point of the first radiation plate may be orthogonal to each other, a third power feed port and a fourth power feed port are disposed also on the second radiation plate in a similar positional relation, and the straight line linking the middle point of the first power feed port and second power feed port and the middle point of the first radiation plate or the straight line orthogonal to this straight line at the middle point of the radiation plate and the straight line linking the middle point of the third power feed port and fourth power feed port and the middle point of the second radiation plate or the straight line orthogonal to this straight line at the middle point of the radiation plate are present on an identical straight line.

13. The antenna device of claim 12, wherein a plurality of radiation plates of which diameter or one side is about ½ wavelength in electrical length are disposed on the ground plate at an arbitrary interval, two power feed ports provided in each radiation plate are disposed so that the power feed ports may cross each other orthogonally with the straight line linking with the middle point of the radiation plate, and each straight line linking the middle point of two power feed ports of each radiation plate and the middle point of the radiation plate are present on an identical straight line.

14. The antenna device of claim 12, wherein the radiation plates are formed as nearly circular radiation plates of about ½ wavelength in electrical length.

15. The antenna device of claim 12, wherein the radiation plates are formed as nearly square radiation plates of which one side or diagonal line is about ½ wavelength in electrical length.

16. The antenna device of claim 12, wherein the ground plate is folded so that an arbitrary straight line between the adjacent radiation plates forms like a hill top.

17. The antenna device of claim 12, wherein the interval from the ground plate to the radiation plates in a region of about ⅛ wavelength in electrical length from the end portions of the radiation plates is narrower than the interval from the ground plate to the radiation plates in other region on the radiation plates.

18. The antenna device of claim 12, wherein the value of dividing the relative permeability by the dielectric constant of a base element between the ground plate and the radiation plate in a region of about ⅛ wavelength in electrical length from the end portions of the radiation plates is smaller than the value of dividing the relative permeability by the dielectric constant of a base element between the ground plate and the radiation plates in other region on the radiation plates.

19. The antenna device of claim 12, wherein four square slits line symmetrical to each straight line linking each power feed port and the middle point of the radiation plates are provided in the radiation plates, and each orthogonal straight line orthogonal to each straight line and two sides of four square slits contact with each other at positions of about ⅛ wavelength in electrical length from the end portions of the radiation plates on each straight line.

20. The antenna device of claim 12, wherein the first power feed port and second power feed port are used in a first system, and the third power feed port and fourth power feed power are used in a second system.

21. The antenna device of claim 12, wherein the first power feed port and third power feed port are used in a first system, and the second power feed port and fourth power feed power are used in a second system.

22. The antenna device of claim 12, wherein each power feed port is connected to the radiation plates by way of gaps.

23. An antenna device wherein a first radiation plate and a second radiation plate of which diameter or one side is about ½ wavelength in electrical length are disposed on a ground plate at an arbitrary interval, a first power feed port and a second power feed port are provided in the peripheral area of the first radiation plate, a first straight line linking the first power feed port provided on the first radiation plate and the middle point of the first radiation plate is orthogonal to a second straight line linking the second power feed port and the middle point of the first radiation plate, a third straight line linking a third power feed port provided on the second radiation plate and the middle point of the second radiation plate is orthogonal to a fourth straight line linking a fourth power feed port provided on the second radiation plate and the middle point of the second radiation plate, the electrical length of the first straight line and the electrical length of the third straight line and the electrical length of the second straight line and the electrical length of the fourth straight line are the identical length, the electrical length of the first straight line and the electrical length of the second straight line are different lengths, and the first straight line and the third straight line or the second straight line and the fourth straight line are present on different lines.

24. The antenna device of claim 23, wherein three or more radiation plates are provided.

25. The antenna device of claim 23, wherein the radiation plates are formed in elliptical shape of which length of major axis and minor axis is about ½ wavelength in electrical length.

26. The antenna device of claim 23, wherein the radiation plates are formed in rectangular shape of which length of major axis and minor axis is about ½ wavelength in electrical length.

27. The antenna device of claim 23, wherein the longer sides or major axes of the adjacent radiation plates cross each other orthogonally.

28. The antenna device of claim 23, wherein the radiation plates are formed in a shape in which the gap between the ground plate and the radiation plates is wider at a position of about ⅛ wavelength in electrical length from the end portion of the radiation plates on a straight line linking each power feed port and the middle point of the radiation plates.

29. The antenna device of claim 23, wherein the value of dividing the relative permeability by the dielectric constant of a base element between the ground plate and the radiation plate is designed to be larger at a position of about ⅛ wavelength in electrical length from the end portion of the radiation plate on the straight line linking the power feed port and the middle point of the radiation plate.

30. The antenna device of claim 23, wherein four square slits line symmetrical to a straight line A linking the power feed port and the middle point of the radiation plate are provided in the radiation plates, and a straight line B orthogonal to the straight line A contacts with two sides of each slit at a point of about ⅛ wavelength in electrical length from the end portion of the radiation plate on the straight line A.

31. The antenna device of claim 23, wherein the ground plate is folded so that an arbitrary straight line between the adjacent radiation plates forms like a hill top.

32. The antenna device of claim 23, wherein the first power feed port and third power feed port are connected to a high frequency circuit in a first system, and the second power feed port and fourth power feed power are connected to a high frequency circuit in a second system.

33. The antenna device of claim 23, wherein the first power feed port and third power feed port are connected to a reception circuit, and the second power feed port and fourth power feed power are connected to a transmission circuit.

34. The antenna device of claim 23, wherein each power feed port is connected to the radiation plates by way of gaps.
